(19) United States
(12) Patent Application Publication
(10) Pub. No.: US 2026/0050648 A1
(43) Pub. Date: Feb. 19, 2026

(54) ARCHITECTURES AND INSTRUCTION SETS FOR NON-GENERAL MATRIX MULTIPLICATION OPERATIONS

(71) Applicant: The Regents of the University of California, Oakland, CA (US)

(72) Inventors: Hadi Esmaeilzadeh, San Diego, CA (US); Soroush Ghodrati, San Diego, CA (US); Sean Kinzer, San Diego, CA (US); Rohan Mahapatra, San Diego, CA (US); Hanyang Xu, San Diego, CA (US)

(21) Appl. No.: 18/803,386

(22) Filed: Aug. 13, 2024

(51) Int. Cl. G06F 17/16

(52) U.S. Cl. CPC G06F 17/16

(57) ABSTRACT

Architectures and instruction sets for non-general matrix multiplication operations are described. An example programmable processor, which implements these architectures and instruction sets, includes multiple processing engines, multiple buffers (with at least one buffer storing a multidimensional array), and multiple iterator tables stored in one of the multiple buffers. The multiple processing engines and multiple buffers are tightly coupled within an area of the programmable processor to enable high-bandwidth data communications between components of the programmable processor. Furthermore, the multiple iterator tables include an iterator table for each of the multiple buffers, and an iterator table enables read or write access to a respective buffer based on using multiple offset-stride tuples stored in the iterator table to derive addresses to access the multidimensional array stored in the respective buffer. Memory elements used by the multiple processing engines to perform operations using the multiple iterator tables consist of the multiple buffers.

### GOVERNMENT LICENSE RIGHTS

This invention was made with government support under Grant Nos. CCF-2107598 and CNS-1822273 awarded by the National Science Foundation, Grant No. HR0011-18-C-0020 awarded by the Defense Advanced Research Project Agency, and Grant No. R01EB028350 awarded by the National Institute of Health. The government has certain rights in the invention.

### TECHNICAL FIELD

This patent document generally relates to computing methodologies, and more specifically, to application-specific processors.

### BACKGROUND

Machine learning (ML) operators are the building blocks to design ML models with various target applications. GEneral Matrix Multiplication (GEMM) operators are the backbone of ML models. They are notorious for being computationally expensive requiring billions of multiply-and-accumulate. Therefore, significant effort has been put to optimize the GEMM operators in order to speed up the execution of ML models. Graphics processing units (GPUs) and accelerators are widely deployed to accelerate ML workloads by optimizing the execution of GEMM operators. However, the performance of non-GEMM operators have not been studied as thoroughly as GEMMs.

### SUMMARY

With the ever increasing prevalence of neural networks and the upheaval from the language models, it is time to rethink neural acceleration. Up to this point, the broader research community, has disproportionately focused on GEMM operations. The supporting argument was that the large majority of the neural operations are GEMM. This argument guided the research in Neural Processing Units (NPUs) for the last decade. However, scant attention was paid to non-GEMM operations and they are rather overlooked. As deep learning evolved and progressed, these operations have grown in diversity and also large variety of structural patterns have emerged that interweave them with the GEMM operations. However, conventional NPU designs have taken rather simplistic approaches by supporting these operations through either a number of dedicated blocks or fall back to general-purpose processors.

Embodiments of the disclosed technology challenge the conventional wisdom in neural accelerator design and explore the architecture of an on-chip companion, sometimes referred to as Tandem Processor, that complements the rather optimized GEMM unit in neural accelerators. This processor needs to be specialized to keep up with the GEMM unit; and yet needs to be programmable to address the (1) structural and (2) operational variations. In some embodiments, to strike a balance between specialization and programmability, on the one hand, we specialize its memory access logic with a novel ISA/microarchitecture that alleviates the register file and its associated load/store operations; on the other hand, the calculations of the non-GEMM layers are only supported through primitive arithmetic/logic vector operations. Therefore, programmability is offered at the mathematical level. The enhancements due to the specialization of the memory access logic in the Tandem Processor and its tight integration with the GEMM unit sustain the throughput and the utilization of the neural accelerator. Comprehensive evaluations of the disclosed design based on the end-to-end execution of seven diverse DNNs including emerging language models show significant performance improvements and energy reduction enabled by leveraging the Tandem Processor.

In some aspects, a programmable processor includes one or more processing engines (with each processing engine being configured to perform a set of primitive operations), one or more buffers (with at least one buffer being configured to store at least one multidimensional array), and one or more iterator tables stored in at least another buffer. In this example, the one or more processing engines and the one or more buffers are tightly coupled within an area of the programmable processor such that data communications between components of the programmable processor are exchanged at a first bandwidth that exceeds a threshold based on a placement of the components of the programmable processor relative to each other. Furthermore, the one or more iterator tables comprise an iterator table for each of the one or more buffers, each iterator table comprises an iterator index and a plurality of offset-stride tuples and identifies a multidimensional array stored in a respective buffer, and a subset of the plurality of offset-stride tuples maps each dimension of the multidimensional array to a set of addresses in the respective buffer. And memory elements used by the one or more processing engines to perform one or more operations using the one or more iterator tables consist of the one or more buffers.

In other aspects, a method of operating a programmable processor includes receiving, by the programmable processor, a first instruction from an instruction set architecture designed for the programmable processor, and performing, based on the first instruction, an operation using at least one of one or more processing engines, one or more buffers, or one or more iterator tables. In this example, the one or more processing engines and the one or more buffers are tightly coupled within an area of the programmable processor such that data communications between components of the programmable processor are exchanged at a first bandwidth that exceeds a threshold based on a placement of the components of the programmable processor relative to each other. Furthermore, the one or more iterator tables comprise an iterator table for each of the one or more buffers, each iterator table comprises an iterator index and a plurality of offset-stride tuples and identifies a multidimensional array stored in a respective buffer, and a subset of the plurality of offset-stride tuples maps each dimension of the multidimensional array to a set of addresses in the respective buffer. And lastly, memory elements used by the one or more processing engines to perform one or more operations using the one or more iterator tables consist of the one or more buffers.

In yet other aspects, the method may be embodied in the form of an apparatus that includes a processor and a memory coupled to the processor.

In yet other aspects, the methods may be embodied in the form of processor-executable instructions and stored on a computer-readable program medium.

The subject matter described in this patent document can be implemented in specific ways that provide one or more of the following features.

### BRIEF DESCRIPTION OF THE DRAWINGS

FIGS. 1A-1C depict repeated subgraphs of example DNNs that illustrate GEMM-based operations being interspersed with non-GEMM operations.

FIG. 2 illustrates a roofline model for a number of prevalent non-GEMM operators.

FIG. 3 illustrates an example of an indirect strided address calculation for scratchpad accesses in the Tandem Processor.

FIG. 4 illustrates an example Tandem Processor pipeline microarchitecture.

FIG. 5 illustrates an example of end-to-end execution on NPU-Tandem.

FIG. 6 illustrates an example of an execution controller and the associated execution finite state machine (FSM).

FIG. 7 illustrates examples of Tandem Processor instruction formats.

FIG. 8A illustrates an example of a general-purpose ISA for a vector add operation.

FIG. 8B illustrates a comparison between the general-purpose ISA and the specialized ISA for the Tandem Processor for the vector add operation.

FIG. 9 illustrates an example of a compilation workflow.

FIG. 10 illustrates a flowchart of an example method of operating a programmable processor (e.g., the Tandem Processor).

FIG. 11 illustrates an example layout of the Tandem Processor.

### DETAILED DESCRIPTION

As used in this patent document, the term “generic processor” is representative of the conventional processor architecture that relies on (and uses) a vector register file. Examples of generic processors include a central processing unit (CPU), a graphics processing unit (CPU), a neural processing unit (NPU), and/or a vector processor.

The example headings for the various sections below are used to facilitate the understanding of the disclosed subject matter and do not limit the scope of the claimed subject matter in any way. Accordingly, one or more features of one example section can be combined with one or more features of another example section.

### 1 Introduction

Deep neural networks (DNNs) have taken the IT industry and almost every computing research community by storm. Their compute intensity has heralded an era of neural accelerators or neural processing units. These designs have disproportionately focused on convolutions, then later on more broadly on GEMM operations. The rationale was that more than 99% of operations of neural networks are of this type. Researchers have focused on optimizing the design for these GEMM operations from various aspects including but not limited to sparsification, bit-level flexibility, use of resistive technologies, analog computations, in/near memory computation, data flow optimizations, to name a few. These implementations have been effective in optimizing the runtime and energy efficiency of GEMM-based operations. However, neural networks are not and were not just a series of matrix multiplications. Yet, scant attention has been paid to the non-GEMM layers and neural networks have been treated as simply a sequence of GEMM operations even in commonly used neural accelerator simulators.

The scale has already shifted as new neural models have emerged. Given the rising prevalence of neural networks and the transformative impact of language models in generative AI applications, non-GEMM operations have increased significantly in number, variety, and the structure of connectivity. For instance, VGG-16, as the first generation of DNNs, includes non-GEMM operations from only three types. Whereas the types of non-GEMM operations have increased to ten for language models (e.g., BERT, GPT-2), as the current generation of DNNs.

The non-GEMM operations are traditionally delegated to a few dedicated blocks (e.g., the ReLu/MaxPool units). However, this approach is not sustainable as the variety of the non-GEMM operations and their structural connectivity to other layers increase. Clearly, there is a need for a rather significant degree of programmability. As such, alternative to or in addition to these blocks, an off-chip general-purpose processor or an on-chip one is designated to handle non-GEMM operations. It has been currently observed that runtime effects of the non-GEMM operations grow in dominance and they are not a rather small and limited minority. Their runtime effects are amplified as the GEMM unit has been polished and optimized over the past decade. Due to these optimizations, Amdahl's bottleneck is shifting towards these non-GEMM operations. Moreover, the non-GEMM counterpart needs to keep up with this optimized GEMM unit to sustain both of their utilization levels.

To address these challenges, the described technology provides, in some embodiments, a specialized, yet programmable processor, which acts as a companion to the GEMM unit. In other embodiments, this specialized processor acts as the primary processor. This specialized processor, named the Tandem Processor, not only handles the execution of the non-GEMM layers, but also orchestrates the end-to-end DNN execution and operand delivery between units. To strike a balance between specialization and programmability, on one hand, its ISA and memory semantics is specialized to alleviate the register file and its associated load/store operations. These specializations are derived from the common patterns of accesses in non-GEMM layers that rearrange and process data elements in a nested-loop fashion. On the other hand, the calculations of the non-GEMM layers are only supported through primitive arithmetic/logic vector operations to offer programmability at the mathematical level.

The Tandem Processor is evaluated with respect to end-to-end execution of seven diverse models (or benchmarks), ranging from rather classical DNNs to the emerging language models, when the Tandem Processor or the alternative design points augment the same GEMM unit. The results show that a balanced design offers significant advantages (2.7× speedup and 20.6× energy reduction) over the common practices of using dedicated blocks that may also require help from the off-chip host processor. In an iso-resource setting, utilizing the Tandem Processor outperforms the use of on-chip multi-core RISC-V processors by 5.9×. Compared to a TPU-like design that augments the GEMM unit with an on-chip general-purpose vector unit, leveraging the Tandem Processor offers 2.6× end-to-end speedup and 1.4× energy reduction. Comparison with NVIDIA's Jetson Xavier NX GPU that leverages NVDLA accelerator shows 4.8× improvements in performance-per-Watt with ˜12× less resources. Finally, in an iso-TOPs setting, comparison to NVIDIA A100 GPU with TensorRT execution shows that the proposed design matches A100 performance, while the Tandem Processor provides 3.4× acceleration only for non-GEMM operations.

### 2 Non-GEMM Operations

### 2.1 Characteristics of Non-GEMM Operations

Non-GEMM operations are significantly diverse. Table 1 (shown below) summarizes the non-GEMM operators used for inference across a set of diverse DNN models. These layers can be categorized into five classes: (1) element-wise mathematical operations, (2) element-wise activation functions, (3) reduction-based operations, (4) data layout transformation operations, and (5) data type conversion operations. Non-GEMM operators fundamentally differ from GEMM ones. They exhibit a wide diversity in terms of compute operations ranging from simple mathematical operations (e.g., Add, Mul, etc.) to complex ones (e.g., Gaussian error linear unit (GeLU), Exp, etc.) as opposed to the commonly used multiply-accumulate in GEMM layers. Moreover, they require various patterns of mapping between input and output tensors, from one-to-one in element-wise operations to many-to-one in reduction-based ones.

TABLE 1
Non-GEMM Operators

| Non-GEMM Operator | |
|---|---|
| Class | Operator Examples |
| Element-wise mathematical | Add, Sub, Mul, Exp, Sqrt, Floor, Ceil, |
| operators | Greater, Equal, Less, Pow, Reciprocal |
| Element-wise activation | Relu, LeakyRelu, Clip, Tanh, Sigmoid, |
| function | GeLU |
| Reduction-based operators | Depth-wise Conv, MaxPool, |
| | GlobalAveragePool, ReduceMean, |
| | SoftMax |
| Data layout transformation | Transpose, Reshape, Concat |
| Type conversion | Cast, BitShift |

Usage frequency of non-GEMM operations is continuously growing. Across all the seven benchmarks discussed herein, only 15% of total DNN operator nodes are GEMMs.

Non-GEMM operations impose non-trivial runtime overheads in newer DNNs. When comparing (1) a GEMM unit with an off-chip CPU, (2) a GEMM unit coupled with a set of dedicated units and the same off-chip CPU, and (3) NVIDIA A100 GPU that leverages tensor cores and INT8 execution mode, it is seen that as the non-GEMM layers become more diverse and complex in newer models such as EfficientNet, BERT, and GPT-2 they also become the main source of the execution bottleneck. For instance, the execution of non-GEMM layers take up 73% of the runtime for EfficientNet for the GPU.

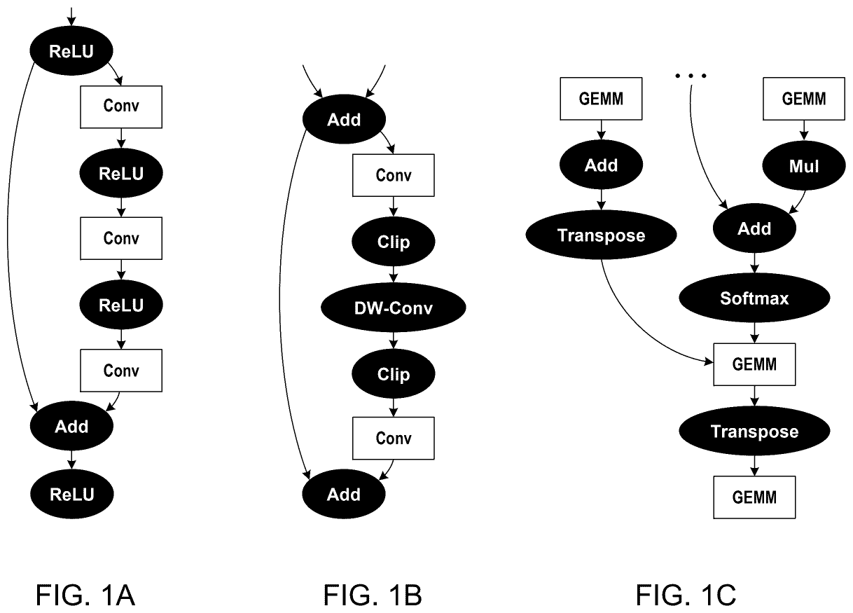

Non-GEMM operations are interspersed amongst GEMM operations. FIGS. 1A-1C depict the core and frequently used subgraphs of three representative DNNs (e.g., ResNet-50, MobileNetv2, and BERT, respectively). As shown therein, the non-GEMM operators are interspersed amongst the GEMM ones (e.g., Conv) with various forms of connectivity. This structure demands back-and-forth data exchange between GEMM and non-GEMM units through off-chip or on-chip memory. On top of this data exchange, tensor reformatting such as datatype casting and tensor layout transformations may be required. For instance the GEMM unit may operate with INT-8/16 mode, while the non-GEMM unit operates in FP32 mode.

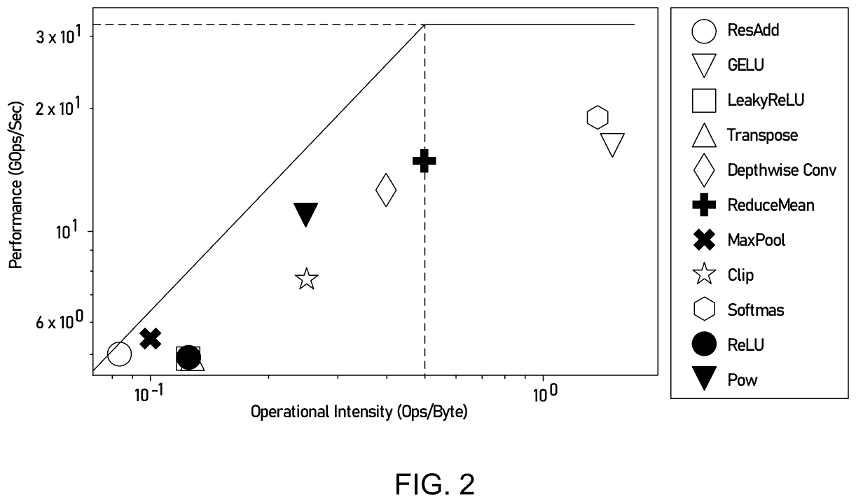

The majority of non-GEMM operations are memory-bound. The majority of non-GEMM layers are element-wise operations (>80%). Moreover, the ones that are not element-wise exhibit low compute intensity and data reuse. FIG. 2 shows a roofline analysis for a set of prevalent non-GEMM operators. As shown therein, most of the analyzed operators (other than SoftMax and GeLU) fall within the memory-bound region of the roofline. This is in contrast to Conv/GEMM operations that are generally compute-bound. Having recognized this distinction, the architecture design has been reconsidered in the development of the Tandem Processor.

### 2.2 Requirements for Executing Non-GEMM Operations

In view of the above characteristics, the three key requirements to efficiently execute non-GEMM operations, which are met by the described embodiments, are:

(1) In-tandem execution of GEMM and non-GEMM operations. To reduce the data exchange among consecutive layers (GEMM and/or non-GEMMs) through off-chip memory, previous implementations have used layer fusion. Layer fusion preserves the intermediate activation values stationary on the chip for subsequent DNN operations. To leverage this technique, the intermediate activations ought to be communicated between GEMM and non-GEMM units via on-chip memory subsystem for a sequence of fused layers. However, this data communication at the granularity of entire layer outputs is neither trivial nor efficient, due to the limited on-chip memory of the accelerators and reduced utilization of GEMM and non-GEMM units. The described embodiments perform the data transfer at a finer granularity of a chunk of output tensor, a.k.a., a tile. This fine granularity of coordination is achieved, for example, by requiring the non-GEMM unit to seamlessly work in tandem with the GEMM unit, while retaining minimal data transfer and reformatting overhead.

(2) Balanced efficiency and programmability for the non-GEMM unit. The diversity of the non-GEMM operators calls for a degree of programmability in the hardware. Nonetheless, this should not emerge at the cost of noticeable efficiency reductions. This is important because the inefficiency of the non-GEMM unit can potentially make it the performance bottleneck and result in stalling the GEMM unit. The described embodiments crucially strike a balance between programmability and specialization.

(3) Orchestrating the execution across non-GEMM and GEMM units. Having both GEMM and non-GEMM acceleration units in one coherent system requires adequate support for execution orchestration. In particular, in some embodiments, (1) DNN nodes are effectively dispatched to their pertinent processing units, (2) and GEMM and non-GEMM units diligently synchronize and handshake together at the right time to realize in tandem execution and back-and-forth interactions.

### 2.3 Existing Approaches for Executing Non-GEMM Operations

Various aspects of the described embodiments are compared to previous methods and implementations in Table 2, and further discussed below.

TABLE 2
Comparison of prior implementations
for supporting non-GEMM operators

| | Working in | | | |
|---|---|---|---|---|
| | tandem with | Special- | Programm- | Execution |
| Design classes | GEMM unit | ization | ability | Control |
| Off-chip CPU fallback | No | No | Yes | Yes |
| Dedicated on-chip | Yes | Yes | No | No |
| hardware units | | | | |
| On-chip RISC-V core | No* | No* | Yes | Yes |
| (+dedicated units) | | | | |
| General purpose | Yes | No* | Yes | |
| vector unit | | | | |
| Tandem Processor | Yes | Yes | Yes | Yes |

where No* indicates that this aspect is supported partially.

Class (1) Off-chip CPU fallback. This approach provides ultimate programmability and handles the end-to-end execution orchestration. However, it impedes the performance due to the lack of specialized execution and in tandem execution with the GEMM unit, which the latter is caused by the nontrivial back-and-forth data transfer between the GEMM unit and CPU over PCIe and required data conversions (e.g., integer to float and vice versa).

Class (2) Dedicated on-chip hardware units. An alternative strategy is the GEMM unit being equipped with a set of dedicated units customized for specific non-GEMM operations. These dedicated units can often be tightly integrated with the GEMM unit (work in tandem), but do not offer execution orchestration. Another drawback is its lack of scalability to augment neural accelerators with dedicated units for each single type of non-GEMM operation. This also prohibits the accelerator from supporting emerging non-GEMM operations as a result of evolving DNNs. In the case of unsupported operations, these accelerators must still fall back to an off-chip CPU.

Class (3) On-chip RISC-V core. The on-chip core in these designs executes the non-GEMM operators and controls on-chip resources. In an example, Gemmini extends the RISC-V ISA with a set of dedicated units/instructions for a limited set of non-GEMM layers. Although this approach obviates off-chip CPU communication, the overheads of datatype casting and layout conversion remain, and block in-tandem execution. More importantly, an on-chip core that has a single arithmetic logic unit (ALU) lacking in terms of compute power and efficiency to process the non-GEMM layers, can become the execution bottleneck.

Class (4) On-chip general-purpose vector unit. Nvidia Streaming Multiprocessor (SM) units that consist of tensor cores (GEMM units) and CUDA cores (general-purpose vector units) belong to this design class. Another notable example is the Vector Processing Unit (VPU) in Google's TPU and other industrial designs. Vectorized execution leverages the inherent parallelism in non-GEMM layers for increased performance improvement. Additionally, these vector units often work in tandem with the GEMM units. However, these units do not handle the execution control and fall short in terms of specialization. Other related industry designs include SiFive x280 and Meta MTIA v1. SiFive x260 is a multi-core vector processor with RISC-V vector extensions for deep learning workloads. The design does not include a GEMM unit but provides a set of communication protocols that can be leveraged to integrate this multi-core vector processor with a GEMM unit. Another design point is Meta's MTIA v1. This design comprises a grid of Processing Elements (PEs). Each PE comprises a GEMM unit and three other units to support non-GMEM operations: (a) a single instruction, multiple data (SIMD) array of dedicated units to support activation functions and typecast operations, (b) a general-purpose core with RISC-V vector extensions to provide further programmability for more complex non-GEMM operations, and (c) a memory layout unit that support transpose/reshape types of operations. In a sense, this design follows both Class (2) and Class (4) of accelerators and includes both dedicated units and general-purpose vector cores.

### 3 Design Aspects of the Tandem Processor

The described embodiments provide several aspects that include an alternative memory subsystem design, a specialized on-chip data access mechanism, specialized loop execution, an alternative ALU design, and integration with the GEMM unit.

### 3.1 Example Memory Subsystem Design

The low computational intensity and the sizable tensor operands for non-GEMM operators prompt the memory subsystem to repeatedly stream data from off-chip memory. Thus, a locality-oriented hierarchical memory sub-system (i.e., vector register file and cache(s)) and conventional load/store data communication, necessitate an excessive number of memory instructions to deliver off-chip data to/from vector register files, funneling through the memory hierarchy.

The described embodiments rely on the insight that non-GEMM layers most often operate on statically-structured tensor operands with a-priori known dimensions in a streaming fashion. Thus, the Tandem Processor replaces the entire vector register file and cache hierarchy with a collection of single-level software-managed on-chip scratchpads. This design is in contrast to all prior SIMD designs that rely on register file execution and memory semantics (e.g., Google's VPU). These load/store operations to vector register files on average impose 41% and 27% runtime overhead for non-GEMM operations and end-to-end execution, respectively. To manage data movements between off-chip/on-chip memories, the described embodiments provide a Data Access Engine. This unit can be configured and invoked by few explicit load/store instructions per tile to fetch entire tensors. Such data movement merely appears at the boundary of a tile, blocking any further intervention from the off-chip memory.

### 3.2 Specialized On-Chip Data Access Mechanism Example

Using large on-chip scratchpads submits a new challenge as fitting the scratchpad addresses in an Instruction Word as opposed to IDs of registers would require significant increase in instruction length. In addition, on-chip address calculations require excessive number of arithmetic instructions. For instance, per two-operand arithmetic/logic instruction, three extra instructions would be required solely for address calculation. This address calculation would impose runtime overheads: On average, 59% of the runtime for non-GEMM layers and 40% of end-to-end DNN runtime.

To tackle this challenge, the described embodiments provide a dedicated pipeline stage for address calculation at the front-end, relieving the burden of address calculation from compute units. In some examples, the embodiments regulate walking over each dimension of tensor operands by a tuple of (Offset, Stride). Hence, if these tuples can be embedded in a single instruction along with compute operations, upon being inferred at the decode stage, the scratchpad addresses can be calculated in parallel with compute operations. Yet, providing three such tuples for a non-GEMM layer would still require significant increase in instruction length. Instead, we forge scratchpad accesses through indirect strided address calculations.

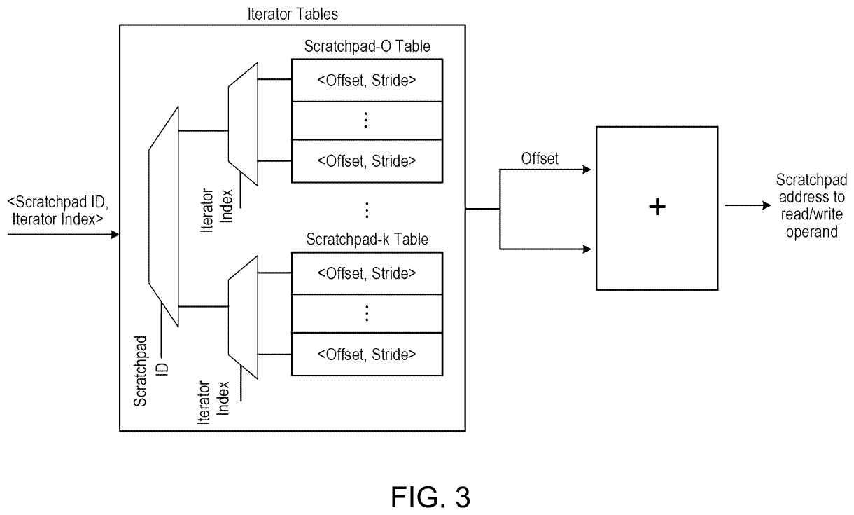

FIG. 3 illustrates an example this feature. The strided accesses are formulated using (Scratchpad ID, Iterator Index) format. The Scratchpad ID is used to select the corresponding scratchpad iterator table and the Iterator Index points to an entry in the Iterator Table. Each entry in the Iterator Table stores a tuple of (Offset, Stride) for each operand. This design optimization realizes the embedding of strided addresses and compute operations into a single 32-bit instruction word (as further discussed in Section 5). With this mechanism, the described embodiments support address calculation as well as compute operation on the same pipeline path with shared control and incur no extra runtime overhead. This is in contrast to previous implementations which leverage decoupled access/execute engines with register files/FIFOs for data access and address generation.

### 3.3 Example of Specialized Loop Execution

Non-GEMM layers are formed of nested loops of primitive operations with pre-determined iteration counts. Using conventional loop logic (i.e., conditional branching) incurs on average 70% and 47% runtime overhead for non-GEMM layers and end-to-end DNN execution, respectively. To alleviate this, the described embodiments provide specialized loop execution semantics, and remove the branch prediction logic.

In some embodiments, this is achieved by using software-managed tables in the fetch pipeline stage to orchestrate the execution of nested loop constructs in hardware. Prior to execution, these tables are configured once with the iteration counts and corresponding number of nested loop levels. Once configured, these specialized tables are used repeatedly in conjunction with the iterator tables to execute the loop body. This is crucial, since appropriate (Offset, Stride) tuples need to be employed at each level of loop nest to correctly calculate the scratchpad addresses. This specialized loop execution is unique to the Tandem Processor, as prior implementations leveraged hardware-managed loop logic with register-file based designs and did not offer mechanisms to combine it with address calculation.

### 3.4 Example Arithmetic Logic Units Design

ALU operations. To support a diverse set of non-GEMM layers, one approach would be to use dedicated specialized instruction for each layer. However, this would lead to a design similar to Class (2) in Section 2.3. Instead, the described embodiments leverage the feasibility of implementing complex non-GEMM layers with a set of simple primitive operations. For instance, GeLU operator can be implemented using five multiplications, three additions, a sign, an absolute, and a minimum operations. A union set of these primitives that is comprehensive enough to support the non-GEMM layers shown in Table 1. As a result, the Tandem Processor offers better hardware resource utilization and reuse across a larger set of operations.

In some embodiments, the primitive operations supported by the ALU include ADD, SUB, MUL, MACC, DIV, MAX, MIN, SHIFT, NOT, AND, OR and NOP. Furthermore, higher order operations or macros (e.g., SIGMOID, TANH, CLIP, ABS, SIGN, FLOOR, CEIL, GELU, SoftMax) can be supported through a combination of primitive operations. Some examples of higher order operations and/or macros include:

$$CLIP = 1 \times MAX + 1 \times MIN$$

$$GeLU = 5 \times MUL + 3 \times ADD + 1 \times SIGN + 1 \times ABS + 1 \times MIN$$

$$SoftMax = 4 \times ADD + 4 \times MUL + 1 \times FLOOR + 1 \times MAX + 1 \times SUB$$

ALU precision and datatype. Prior research shows that integer-only arithmetic can be used for inference execution of CNNs and transformers with virtually no repercussions on accuracy. Also, while GEMM and few non-GEMM layers (e.g., Relu) are amenable for low-precision INT8 implementation, some non-GEMM layers such as ResAdd and SoftMax require INT32. To provide sufficient precision for all non-GEMM operators, the described embodiments use INT32 for the Tandem Processor ALUs. As a complementary benefit, additional data casting from GEMM to non-GEMM unit is not needed, since GEMM units typically accumulate the partial results in INT32 precision. To support lower precision for GEMM, a datatype casting instruction is required when activations move from non-GEMM to GEMM unit.

3.5 Example Integration with the GEMM Unit

Coordination granularity. The described embodiments use tile (sub-tensor) granularity for software pipelining to facilitate execution overlap between GEMM and non-GEMM units, improve resource utilization, and better conform with limited on-chip memory capacity. The in-tandem coordination of the GEMM unit and the Tandem Processor at a tile granularity increases the compute resource utilization by 20% and 13% for the GEMM unit and the Tandem Processor, respectively. Note that an operand-level granularity is less efficient. This is because some non-GEMM operators, such as depth-wise convolution, require arbitrary accesses to GEMM outputs for consecutive operations. This access pattern results in frequent stalls, curtailing the overall performance.

Communication mechanism. To enable tile-based coordination, one probable approach is to directly move/copy tiled data from the GEMM unit's Output BUF to the Tandem Processor's private scratchpads. However, this design decision incurs communication overhead at the boundary of each accelerator units, requiring complex coordination mechanism. Alternatively, the described embodiments enable a fluid ownership of the GEMM unit's Output BUF for the Tandem Processor, obviating redundant data communications. After the GEMM unit completes storing the intermediate data in the Output BUF, the Tandem Processor takes the ownership of the buffer and directly executes its computations on the stored data.

Synchronization mechanism. To enable this fluid ownership while simplifying hardware, the compiler is leveraged to weave a set of synchronization instructions (as discussed in Section 5) between GEMM and non-GEMM instructions that realize the following: (1) They identify the code regions for the GEMM unit and the Tandem Processor, facilitating the instruction dispatch. (2) They define the flow of execution between GEMM and non-GEMM units. (3) They govern the handshaking mechanism between the acceleration units. For example, enforcing the release of ownership of the Output BUF after the Tandem Processor completes the execution.

### 4 Microarchitecture Design Example for the Tandem Processor

### 4.1 Pipeline Design Example

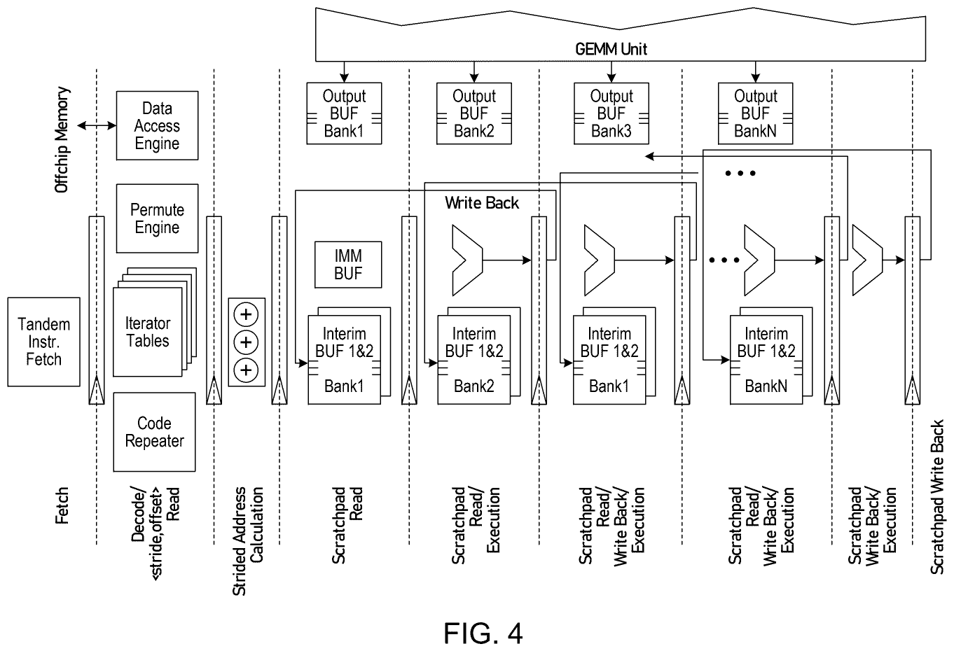

This section describes the major aspects of the Tandem Processor's pipeline microarchitecture, an example of which is illustrated in FIG. 4.

On-chip memory organization. The Tandem Processor scratchpads are referred to as Namespaces (e.g., IMM BUF, Interim BUF and Output BUF in FIG. 4). Interim BUF 1&2 namespaces represent the central Tandem Processor's on-chip scratchpads that operate as a storage medium for tensor operands as well as their intermediate results. These scratchpads, which bridge the off-chip memory and the Tandem Processor, are populated/drained by a Data Access Engine at a tile granularity. The Tandem Processor compiler configures the Data Access Engine by setting the base address of the off-chip source along with a series of stride values. Note that, the tiled data may be even dispersed across non-contiguous regions of memory lines, yet statically arranged in strided patterns. IMM BUF namespace serves as a small 32-slot scratchpad for immediate values in non-GEMM operations. This buffer is programmed with a series of customized instructions at the onset of non-GEMM layer execution. The last namespace is Output BUF, which serves as the GEMM Unit's buffer for output values.

Specialized on-chip data access. The Iterator Tables that are used to store the offset and stride information for scratchpad accesses are placed at the decode stage of the Tandem Processor pipeline (shown as “Decode” in FIG. 4). There is a dedicated Iterator Table for each namespaces of the Tandem Processor. Upon decoding one arithmetic/logic instruction, the (Namespace ID, Iterator Index) retrieves the address calculation information from the corresponding Iterator Table. The resulting output of accessing the Iterator Tables is a triplet address, two for source operands and one for destination operand. Each element of the triplet is a tuple of (offset, stride), indicating that target data resides in Scratchpad [offset+stride]. The triplet address is passed down to the subsequent pipeline stage (Strided Address Calculation) that repetitively assembles a series of scratchpad addresses, each as the result of offset+stride computation. The scratchpad indices propagate down the multi-staged execution pipeline to fetch the tiled operands, perform the non-GEMM operations, and write back the resulting data to the pipeline back-end.

Nested loop support. The Code Repeater module (shown on the left side in FIG. 4) uses three tables: A table stores the compiler-defined iteration counts. Each entry of this table maintains the configuration of one of the loop nesting levels, ordered from outermost loop to the innermost one. At the Decode pipeline stage, Code Repeater stores the number of iterations in each table entry, which is indexed using a pointer that keeps track of the number of nested loops. Once the Code Repeater is configured, it uses the second table with similar structure of entries to keep track of the current iteration of the loops. Whenever, the Code Repeater exhausts the iterations of a loop level, it decrements the pointer to update the iterations of the ensuing outer loop. Finally, the Code Repeater uses a collection of identical tables that store the information about what Iterator IDs need to be exercised for each operand at a certain loop level.

### 4.2 Example Overall Execution Flow and Synchronization Logic

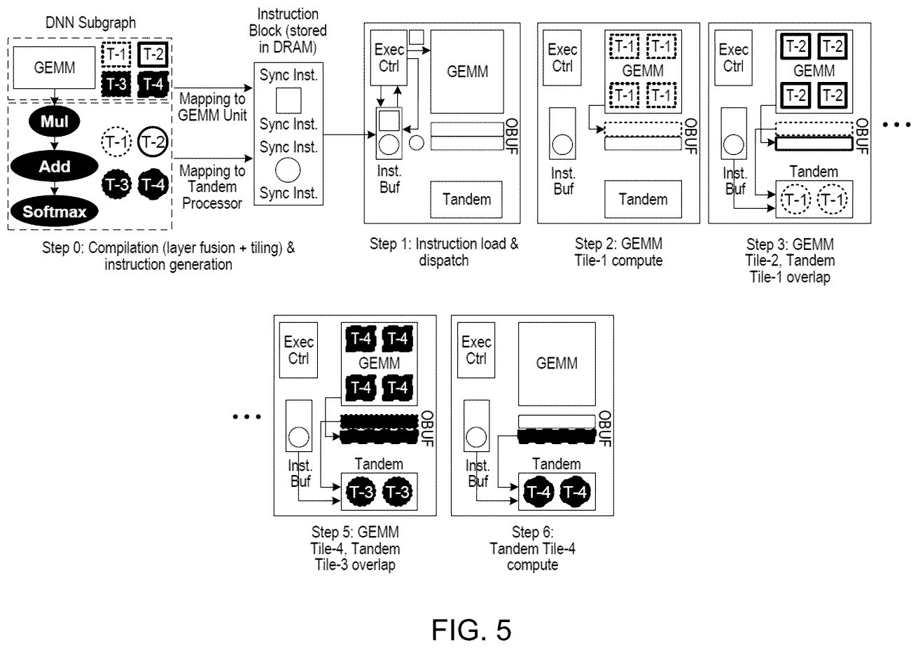

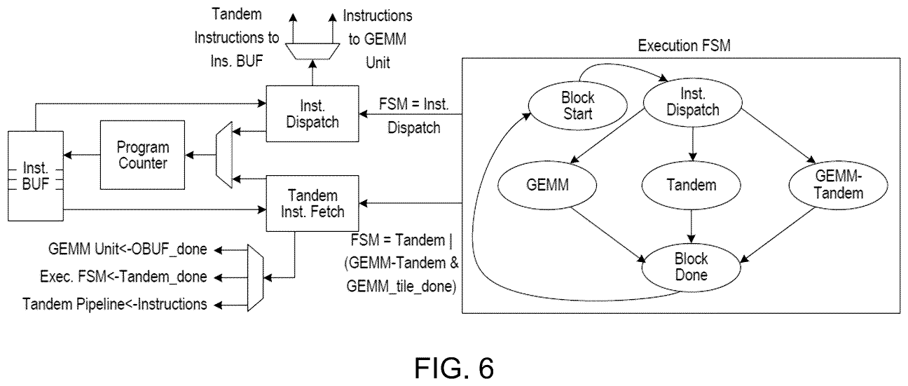

FIG. 5 illustrates an example of the overall execution for a DNN subgraph on the NPU-Tandem. As shown therein, at a high level, the NPU-Tandem encompasses (1) a GEMM unit (including weight/input buffers), (2) Output Buf, which serves as a medium for communicating data from GEMM unit to the Tandem Processor, (3) an execution controller that orchestrates the overall execution and facilitates the synchronization between units, and (4) an instruction buffer that holds the instructions of the block. To execute DNNs, the compiler breaks the DNN graph into a set of execution blocks or subgraphs (step 0 in FIG. 5). A block can be one of the following: (1) a single GEMM layer, (2) a group of bundled non-GEMM layers, (3) a GEMM layer followed by a group of bundled non-GEMM layers (shown in this example). To realize the in-tandem execution, a uniform tiling scheme is required across the inputs/outputs of fused layers in one block. FIG. 5 shows four tiles of execution for fused GEMM (shown with squares) and non-GEMM layers (shown with circles). As Section 5 discusses, the synchronization instructions mark the boundaries of GEMM and non-GEMM instructions (see the instruction block format in Step 0 of FIG. 5). FIG. 6 illustrates the high level view of the execution controller logic for the Tandem Processor. Below, the overall execution on the NPU-Tandem is discussed.

Instruction load and dispatch (Step 1 in FIG. 5). First, the Tandem Processor loads the instructions of a block from off-chip memory into its Inst. BUF. Then, the FSM of the execution controller switches from Block Start to Inst. Dispatch state (see FIG. 6). At this state, the Tandem Processor's Inst. Dispatch unit drives the Program Counter to walk over all the instructions of a block. Note that this is a lightweight decode state and does not invoke any execution on the GEMM unit or Tandem Processor. The Inst. Dispatch unit decodes the synchronization instructions to identify the topology of the block (GEMM only, non-GEMM only, or GEMM followed by non-GEMM). It then decodes the GEMM instructions and configures the GEMM unit, while writes back the non-GEMM instructions to the Inst. BUF. Note that GEMM units typically operate at macro operations level (e.g., Conv or Matmul instructions), when first a set of instructions are decoded to configure the GEMM unit. Based on the configuration, this unit then operates in a repetitive mode to fully execute the GEMM layers. In contrast, the Tandem Processor is similar to von Neumann machines, where each instruction is decoded and executed through the processor pipeline. As such, at the end of this state, only non-GEMM instructions exist on Inst. BUF to be decoded and executed by the Tandem Processor. After the dispatch is done, based on the structure of the program block, the execution FSM switches to either of these three states: the GEMM state, the Tandem Processor state, and the GEMM-Tandem Processor state (see FIG. 6).

GEMM-non-GEMM execution (Step 2 to Step 6 in FIG. 5). If a GEMM layer is followed by a series of non-GEMM layers, the FSM transitions to the GEMM-Tandem Processor state after the instruction dispatch. GEMM unit first starts with executing the first tile (Step 2 in FIG. 5). Whenever the GEMM unit finishes the tile, it sends a handshaking signal to the execution controller. If the Tandem Processor is idle, the execution controller invokes Tandem Inst. Fetch unit to start the execution of non-GEMM tile (see (FSM=Tandem|FSM=GEMM-Tandem) & GEMM_tile_done signal in FIG. 6). Utilizing a double-buffering scheme, the GEMM unit proceeds to the next tile, while the Tandem Processor takes the outputs of the GEMM-completed tile and performs the non-GEMM operations (Step 3 in FIG. 5). To avoid stalls in the GEMM unit caused by the Output BUF being occupied by the Tandem Processor, the compiler inserts a synchronization instruction (as discussed in Section 5) right after the instructions consuming the data on the Output BUF. At this time, the Tandem Inst. Fetch sends a handshaking signal to the GEMM unit and Tandem Processor releases the Output BUF (OBUF_done→GEMM Unit in FIG. 6). The Tandem Processor may continue the computation using its private Interim BUFs. Once the Tandem Processor finishes a tile, it uses the synchronization instruction that marks the end of the non-GEMM program to alert the execution FSM (Tandem_done→Exec. FSM in FIG. 6). The execution FSM puts the Tandem Processor in the idle state until it receives the next tile from GEMM unit. After finishing the all tiles (Steps 2 to 6 in FIG. 5), the execution FSM transitions to the Block Done state (see FIG. 6).

Non-GEMM only execution. The execution FSM transitions from Inst. Dispatch to Tandem state and triggers the Tandem Inst. Fetch to fetch the non-GEMM instructions and forward them to Tandem Processor pipeline. Once Tandem Processor completes executing all the instructions, the Tandem Inst. Fetch unit sends a handshaking signal to the execution FSM logic. The execution FSM loops back to this state if there are remaining tiles. To ensure the off-chip memory access instructions are updated for different tiles, the first tile is used to initialize configurations for the Data Access Engine. For rest of the tiles, the Data Access Engine reuses the initialized configurations and incrementally updates them.

### 5 Example Instruction Set Architecture Design for the Tandem Processor

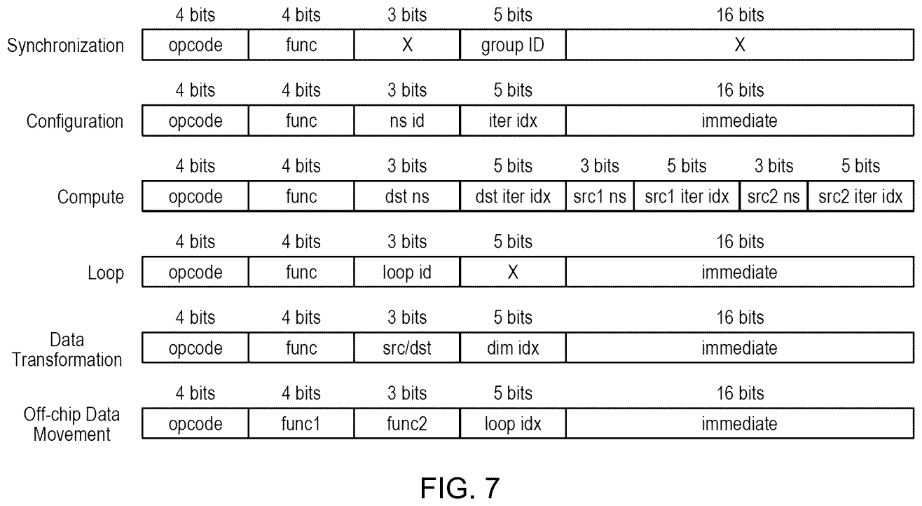

An instruction set architecture (ISA) is part of the abstract model of a computer that defines how a processor (e.g., CPU, GPU, NPU, vector processor) is controlled by the software. The ISA acts as an interface between the hardware and the software, specifying both what the processor is capable of doing as well as how it gets done. FIG. 7 summarizes the instruction formats for the Tandem Processor. The associated instruction classes include:

Synchronization instructions. In this class, the func bits are defined as (GEMM/SIMD, START/END, EXEC/BUF, X). The START and the END bits along with EXEC bit mark the regions of instructions that belong to the Tandem Processor and GEMM Unit (identified with GEMM/SIMD bit accordingly), which helps dispatch instructions to the appropriate unit. Also, this instruction can be used with EXEC bit to notify the GEMM Unit that the execution of non-GEMM operations of the running tile is completed, or with BUF bit to notify the GEMM Unit that the OUTPUT BUF is released and ready for the subsequent tile.

In some embodiments, examples of using the synchronization instruction include:
sync, tandem_processor/GEMM Unit/ . . . , start, execution, instruction_group_id
sync, tandem_processor/GEMM Unit/ . . . , end, execution, instruction_group_id
sync, tandem_processor/GEMM Unit/ . . . , end, output_buffer_release, instruction_group_id

The synchronization instructions define the boundaries of execution across the GEMM unit and the Tandem Processor, and the “output_buffer_release” instruction enables the release of the output buffer for the GEMM Unit as soon as possible, thereby prohibiting the GEMM unit from stalling.

Configuration instructions. This class includes two opcodes. The ITERATOR_CONFIG opcode is used with three functions (func bits): (1) BASE_ADDR to fill the Iterator Tables with the base addresses for the scratchpads and (2) STRIDE to fill the Iterator Tables with strides for the scratchpad address calculation, and (3) IMM BUF to fill the immediate buffer with the immediate values needed for non-GEMM operations. The ns id and iter idx fields identify the target namespace and the index to its corresponding Iterator Table. Also, this instruction is used to set the immediate values in IMM BUF. Another opcode is DATATYPE_CONFIG, which is used for datatype casting.

In some embodiments, examples of using the configuration instructions include:
iterator_config base_addr, namespace_id, iterator_index, value
iterator_config stride, namespace_id, iterator_index, value

With these semantics, the set of configuration instructions act as preamble at the beginning of any instruction block, which results in the iterator tables being filled out with the base addresses and stride.

In some embodiments, other examples of using the configuration instructions include:
datatype_config fxp, src, imm_buf_index, num_integer_bits
datatype_config fxp, dst, imm_buf_index, num_integer_bits

With these semantics, the ISA supports instructions for mixed-precision execution across the Tandem Processor and the GEMM unit through a set of datatype config instructions.

Compute instructions. Opcode ALU is defined with various func bits to support Add, Sub, Mul, MACC, Div, Max, Min, Shift, Not, AND, OR operations on src1 and/or src2 operands. Additionally, this opcode supports MOVE/COND_MOVE instructions for scatter/gather operations. In case of COND_MOVE, the first source operand (src1) is moved predicated upon true/false flags identified by the second operand (src2). Opcode CALCULUS consists of mathematical operations such as absolute value and sign. Opcode COMPARISON supports logical comparisons. The operands (src1/src2/dst) for each instruction are specified by using a 3-bit ns id to locate the buffer, and a 5-bit iter idx corresponding to the stride and offset.

In some embodiments, examples of using the compute instructions include:
alu add, dst_namespace_id, dst_iterator_index, src1_namespace_id, src1_iterator_index, src2_namespace_id, src2_iterator_index

Loop instructions. This class is used with the LOOP opcode to configure the Code Repeater. This opcode is used with SET_NUM_ITER function bits to specify the number of iterations for each loop identified by loop id. The SET_NUM_INST function is used to identify the number of instructions in the loop body. To cope with the customized on-chip memory accesses for each loop dimension, the SET_INDEX function is used, while the rest of the instruction bits are used to set the associated (ns ID, iter idx) for the three operands (similar to compute instructions). The loop instructions are designed to support arbitrary levels of nesting (up to eight, each of which is identified by loop id field) needed by non-GEMM operators.

In some embodiments, examples of using the loop instructions include:
loop set_num_iter, loop_id, num_iterations
loop set_num_inst, loop_id, num_instructions_in_the_loop_body
loop set_index, dst_namespace_id, dst_iterator_index, src1_namespace_id, src1_iterator_index, src2_namespace_id, src2_iterator_index

The first two are examples of using iterator tables to implement for loops, and the third is an example using iterator tables to implement nested for loops.

Data transformation instructions. This class is used with two opcodes: (1) PERMUTE for permuting multi-dimensional tensors using the Permute Engine shown in FIGS. 4 and (2) DATATYPE_CAST for datatype casting. For PERMUTE opcode, SET_BASE_ADDR, SET_LOOP_ITER, and SET_LOOP_STRIDE functions configure the base addresses, shapes, and strides, respectively, for both the source and destination's tensor dimensions (identified by dim idx). Then, with the START function, the iterators start generating the address for the source and destination according to the desired permutation. Additionally, the LSB bit of the Immediate field while using the START function identifies if this permutation operation requires shuffling the data across the SIMD lanes/scratchpad banks or not. DATATYPE_CAST opcode is used to cast tensor elements to various fixed-point representations such as FXP32, FXP16, FXP8, and FXP4 needed by the GEMM unit.

In some embodiments, examples of the data transformation instructions include:
type_cast src_type→dst_type, dst_namespace_id, dst_iterator_index, src_namespace_id, src_iterator_index, imm_buf_namespace_id, imm_buf_index

With these semantics, the ISA supports instructions for mixed-precision execution across the Tandem Processor and the GEMM unit through a set of cast instructions.

Off-chip data movement instructions. TILE_LD_ST opcode describes the data tile transfer between off-chip memory and on-chip memory of the Tandem Processor, Interim BUFs. The func1 field includes various functions: The LD/ST_CONFIG_BASE_ADDR function is used to generate the base addresses of each tile. To configure the corresponding shapes and strides for each tile, the LD/ST_CONFIG_BASE_LOOP_ITER/STRIDE function is used. Also, LD/ST_CONFIG_TILE_LOOP_ITER/STRIDE functions are used to configure the Data Access Engine to generate the addresses required for each tile. Finally, LD/ST_START function triggers the Data Access Engine to start populating/draining the intermediate buffers. The func2 field is used to identify the target buffer between Interim BUF 1&2. In some embodiments, data is moved at the tile granularity is executed through a set of inter-tile walks. In other embodiments, a set of intra-tile walks are executed to access the data at the tile granularity.

In some embodiments, examples of off-chip data movement instructions include:
tile_ld, config_base_addr, namespace_id, loop_id, base_addr
tile_ld, config_base_iter, namespace_id, loop_id, iterations
tile_ld, config_base_stride, namespace_id, loop_id, stride

With these semantics, the ISA supports moving data at the granularity of a tile through a set of inter-tile walks.

In some embodiments, additional examples of using off-chip data movement instructions include:
tile_ld, config_tile_iter, namespace_id, loop_id, iterations
tile_ld, config_tile_stride, namespace_id, loop_id, stride

With these semantics, the ISA supports moving data at the granularity of a tile through a set of intra-tile walks.

5.1 Example Benefits Achieved from ISA Specialization

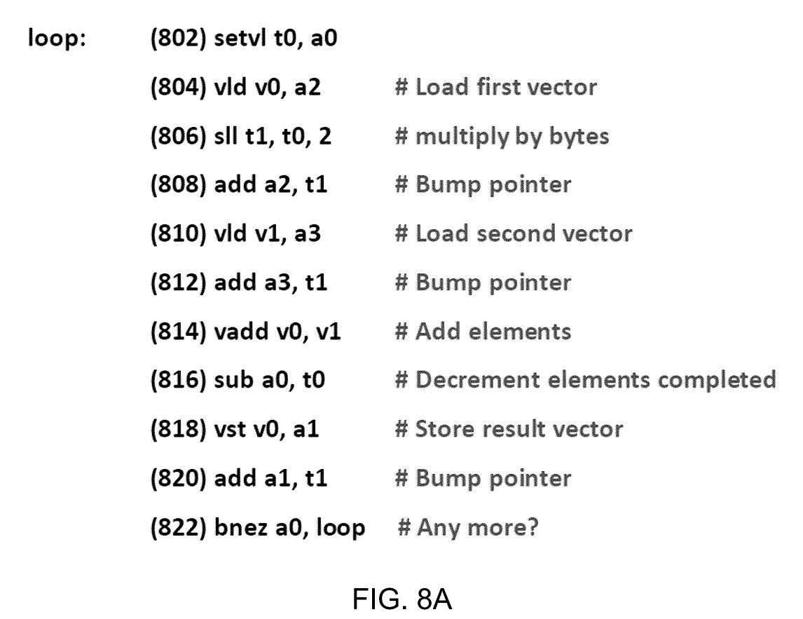

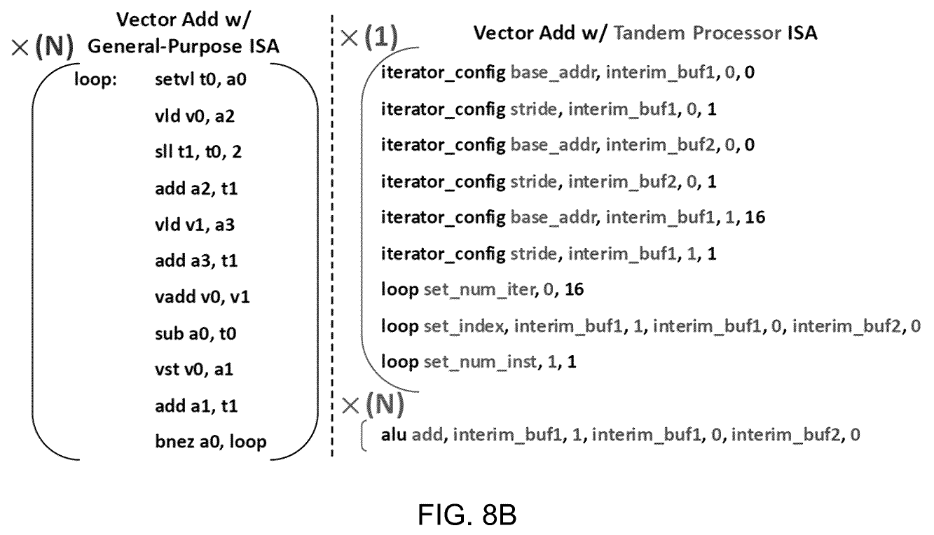

FIG. 8A illustrates an example of a general-purpose ISA for a vector add operation, and FIG. 8B illustrates a comparison between the general-purpose ISA and the specialized ISA for the Tandem Processor for the vector add operation. The example general-purpose ISA for the vector add operation, shown in FIG. 8A, includes:
operations 806, 808, 812 and 820, which are address calculations for loading (LD) and storing (ST) vector operands, and account for 40% of the end-to-end runtime overhead across the DNN benchmark suite discussed (and used) in this patent document;
operations 804, 810 and 818, which are for LD/ST vector operands to a register file (or vector register file), and account for 27% of the end-to-end runtime overhead; and
operations 802, 816 and 822, which are for loop management, and account for 47% of end-to-end runtime overhead.

The analysis of the operations in FIG. 8A make evident that the key inefficiency in a general-purpose ISA is the LD/ST to the register file. The described embodiments eliminate the need to access the register file, and use a 1-level on-chip scratchpad memory. FIG. 8B shows the benefits in using the specialized ISA of the Tandem Processor as compared to a general-purpose ISA for the vector add operation. As shown on the left side in FIG. 8B, when using the general-purpose ISA, all the instructions (e.g., operations 802 through 822) need to be executed N times over the N iterations of the loop. In contrast, as shown on the right side in FIG. 8B, when using the specialized ISA, the configuration instructions for setting up the base and stride parameters for access and loop definitions are executed only once, and only the compute instruction is executed N times for the N iterations of the loop.

### 6 Example Compilation Considerations for the Tandem Processor

Tiling optimization. Compiler realizes software-pipelining by choosing the optimized tiling strategy. To improve the Tandem Processor's utilization, the compiler does not tile the reduction dimensions in GEMM operations. otherwise, the GEMM Unit produces partial results that would be insufficient for the Tandem Processor to perform its operations, causing it to stall. Additionally, the compiler finds the optimal sizes for tiles that are big enough to encompass all the adjacent elements of an input tensor for the non-GEMM operation, while small enough to fit on the limited on-chip scratchpads. For instance, to perform Depth-wise Conv operation with a kernel size 5×5, it would require the Tandem Processor to have access to all the elements in the 5×5 patch or it is inevitable to stall.

Dependency relaxation. The Tandem Processor leverages the regularity in the non-GEMM operations and eliminates the dependency check in the hardware, while shifting the burden to the compiler. The Tandem Processor compiler leverages loop fission to remove dependencies among series of instructions. Additionally, some non-GEMM operations, such as MaxPool, have a long sequence of dependencies among instructions. For such cases, the compiler leverages loop interchange to relax the dependencies.

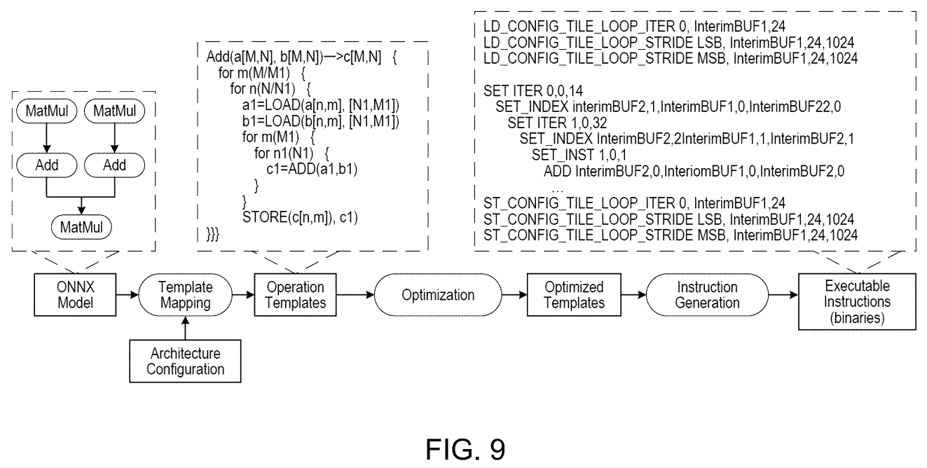

Compilation workflow. FIG. 9 describes the compilation workflow for the Tandem Processor. The compiler uses the ONNX format of DNNs and the architecture configuration of the Tandem Processor (e.g., number of lanes, Interim BUF) as its inputs. The compiler maps the ONNX node to pre-defined operation templates. However, as discussed in Section 3.4, not all non-GEMM operators are directly supported by the Tandem Processor. Therefore, for such complex operations (e.g., SoftMax, SQRT, GeLU) the compiler translates them to an integer-based counterpart. After mapping to the templates, the parameters of the operation templates are replaced with real values according to the ONNX layers. The compiler then performs the aforementioned optimizations. Finally, the compiler iterates the statements in the template and lowers them into instructions based on the Tandem Processor ISA.

LOAD and STORE statements are lowered to TILE_LD_ST with BASE_LOOP_ITER/STRIDE functions for each LOOP variables, to set the number of iterations and strides in DRAM (a summarized version is shown in FIG. 9). Then, the tile transfer instructions (LD/ST_CONFIG_TILE_LOOP_ITER/STRIDE) are generated using the tile shape in the LOAD and STORE statements. Compute operations are lowered to a set of inner LOOP instructions along with the pertinent compute instruction. For compute operations reading from Output BUF, the compiler generates additional synchronization instructions.

### 7 Example Evaluation Methodology and Experimental Results

Benchmarks. To evaluate the efficacy of the Tandem Processor, the benchmark suite was formed from the domains of image classification (VGG-16, ResNet-50, MobileNetv2, EfficientNet), object detection (Yolov3), and emerging language models (BERT, GPT-2) with batch size 1 that is used for real-time AI, single-stream, and offline scenarios. These DNN benchmarks constitute a diverse set of layers with various dimensions and types of operations (e.g., Relu/LeakyRelu/Clip, Max-pool/GlobalAveragePool, Depth-wise convolution, Residual Add, ReduceMean, Exp, Transpose, etc.).

Details regarding the hardware configuration, implementation and synthesis, as well as the simulation infrastructure can be found in “Tandem Processor: Grappling with Emerging Operators in Neural Networks” by S. Ghodrati et al. in ASPLOS '24: Proceedings of the 29th ACM International Conference on Architectural Support for Programming Languages and Operating Systems, Volume 2, pages 1165-1182 (hereinafter “ASPLOS 2024 Tandem Processor”), the entire contents of which are incorporated herein by reference and relied upon.

The performance of the NPU-Tandem is compared with baselines (1) using offchip CPU fallback and (2) using dedicated units. The results are normalized to the baseline (1). On average, the NPU-Tandem provides 3.5× and 2.7× speedup compared to baseline (1) and baseline (2), respectively. The improvements provided by the Tandem Processor are more pronounced for MobileNet-v2 (5.9× over baseline (1) and 5.4× over baseline (2)) and BERT (5.4× over baseline (1) and 4.5× over baseline (2)) due to the use of more complex non-GEMM operations in their structure that significantly affect the total runtime. On average, the NPU-Tandem reduces the total energy consumption by 39.2× and 20.6× compared to baseline (1) and baseline (2), respectively. The results show that generally as DNNs evolve and use more complex structures and non-GEMM operations, the benefits of the Tandem Processor grow.

Comparisons to other specific implementations (e.g., Gemmini, Google's TPU, Jetson Xavier and RTX 2080 TI GPUs, and the A100 GPU) are detailed and discussed in ASPLOS 2024 Tandem Processor.

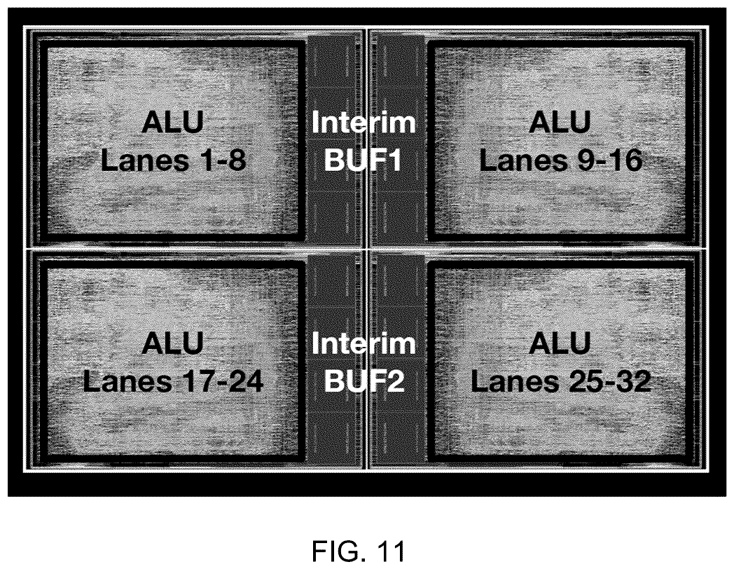

FIG. 11 illustrates an example layout of the Tandem Processor, which is synthesizable on both a field-programmable gate array (FPGA) or an application-specific integrated circuit (ASIC). For the example shown in FIG. 11, the ALU logic occupies the largest area (56.6%), Interim BUF 1 and Interim BUF 2 is the second (29.2%) and the permute logic is the third (12.0%). The rest of the area is mainly for multiplexing logic, pipeline registers, Code Repeater and decode logic.

As discussed herein, the described embodiments (1) leverage unique characteristics of non-GEMM layers and provide a new instruction execution semantic and architecture that does not adhere to the conventional Register-File-centric designs. The disclosed design enables a unique specialized data access semantic for the Tandem Processor, and (2) exploit the common data manipulation patterns in non-GEMM DNN layers and offer a pipeline front-end that leverages microarchitectural mechanisms to keep track of strided iterators. This aspect minimizes the overhead of loop execution, address calculations, and memory accesses.

The described embodiments include a programmable processor that includes one or more processing engines (with each processing engine being configured to perform a set of primitive operations), one or more buffers (with at least one buffer being configured to store at least one multidimensional array), and one or more iterator tables stored in at least another buffer. In this example, the one or more processing engines and the one or more buffers are tightly coupled within an area of the programmable processor such that data communications between components of the programmable processor are exchanged at a first bandwidth that exceeds a threshold based on a placement of the components of the programmable processor relative to each other. Furthermore, the one or more iterator tables comprise an iterator table for each of the one or more buffers, each iterator table comprises an iterator index and a plurality of offset-stride tuples and identifies a multidimensional array stored in a respective buffer, and a subset of the plurality of offset-stride tuples maps each dimension of the multidimensional array to a set of addresses in the respective buffer. And lastly, memory elements used by the one or more processing engines to perform one or more operations using the one or more iterator tables consist of the one or more buffers. As discussed in Sections 3.1 and 5, the described embodiments rely on the insight that load/store operations of a register file impose significant runtime and end-to-end execution overheads, and thus, replace the entire vector register file and cache hierarchy with a collection of single-level software-managed on-chip scratchpads.

In some embodiments, the one or more buffers excludes a register file associated with a generic processor, wherein the one or more processing engines are configured to communicate with the register file at a second bandwidth that is less than the first bandwidth, and wherein the generic processor is a central processing unit (CPU), a graphics processing unit (GPU), a neural processing unit (NPU), or a vector processor

In some embodiments, a single instruction, multiple data (SIMD) configuration of the programmable processor comprises time interleaving (a) one or more compute operations performed by at least one of the one or more processing engines and (b) one or more access operations performed on at least one of the one or more buffers. Pipelining based on interleaving the processing engine operations and the buffer accesses is further described in FIG. 4.

In some embodiments, the iterator table enables read or write access to the respective buffer by computing the set of addresses in the respective buffer using the subset of the plurality of offset-stride tuples.

In some embodiments, one of the one or more iterator tables is associated with one or more of the one or more buffers, i.e., there is a one-to-many mapping between the iterator tables and the buffers. In other embodiments, there is a one-to-one mapping between the one or more iterator tables and the one or more buffers.

In some embodiments, the programmable processor further includes a code repeater module configured to receive an instruction from a program counter, and the instruction specifies performing an operation using at least one of the one or more processing engines, the one or more buffers, or the one or more iterator tables.

In some embodiments, the code repeater module configures, based on the instruction, the one or more iterator tables by computing the set of addresses in the respective buffer using the subset of the plurality of offset-stride tuples, and performs, using the one or more iterator tables, the operation on every dimension of the multidimensional array stored in the respective buffer.

In some embodiments, the programmable processor further includes a data access engine configured to access additional data from an off-chip memory at a second bandwidth that is less than the first bandwidth, and a permute engine configured to receive input data and output a permuted version of the input data based on a predefined permutation sequence. In some examples, the data access engine is configured to access the additional data from the off-chip memory at a tile granularity, and wherein the programmable processor is configured to process multiple tiles in an intra-tile mode or an inter-tile mode.

In some embodiments, the programmable processor is operated in a standalone configuration for at least one application or in at least one system. In some examples, some applications (e.g., robotics and objection detection, the latter of which can require up to 78% of execution time being spent on non-GEMM operations) are dominated by non-GEMM operations, and in these cases, the Tandem Processor can be configured to operate as a primary processor, and not necessarily in conjunction with another generic processor, e.g., CPU, GPU, NPU, etc.

In some embodiments, the programmable processor is operated in conjunction with the generic processor for at least one application or in at least one system. The in-tandem operation is detailed in FIG. 5.

In some embodiments, the generic processor comprises a general matrix multiplication (GEMM) unit. In some examples, the GEMM unit comprises at least one output buffer, the at least one output buffer is associated with one iterator table to enable read and/or write access thereto. In these examples, the one or more buffers comprises a first interim buffer and an immediate buffer, a first iterator table associated with the at least one output buffer operates with a first datatype, a second iterator table associated with the first interim buffer operates with a second datatype, and a value from the at least one output buffer is converted from the first datatype to the second datatype upon being written into the first interim buffer by the second iterator table. In other examples, the GEMM unit is configured to be active in a first time window, and wherein the programmable processor is configured to be active in a second time window that is non-overlapping with the first time window.

In some embodiments, and as discussed in Section 5, the programmable processor uses an instruction set architecture (ISA) comprising a plurality of instructions. Each instruction has an operation code and is configured to use at least one of the one or more iterator tables.

In some embodiments, the set of primitive operations comprises an addition (ADD) operation, a subtraction (SUB) operation, a multiplication (MUL) operation, a division (DIV) operation, a multiply-and-accumulate (MACC) operation, a maximum (MAX) operation and a minimum (MIN) operation. Other supported primitive operations are further detailed in Section 3.4 and 5. As discussed therein, higher order operations and macros can be supported through various combinations of primitive operations. In some examples, at least one higher-order operation comprises a sigmoid (SIGMOID) operation, a hyperbolic tangent (TANH) operation, a clip (CLIP) operation, a sign (SIGN) operation, an absolute value (ABS) operation, a SoftMax operation, or a Gaussian error linear unit (GeLU) operation.

In some embodiments, the programmable processor is part of an array of programmable processors that are working on conjunction with each other, e.g., a multi-core design can collaboratively use multiple Tandem Processors.

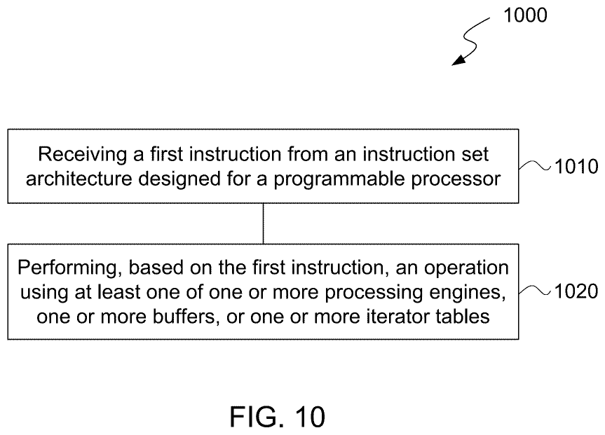

FIG. 10 illustrates a flowchart of an example method 1000 of operating a programmable processor. The method 1000 includes, at operation 1010, receiving a first instruction from an instruction set architecture designed for a programmable processor.

The method 1300 includes, at operation 1020, performing, based on the first instruction, an operation using at least one of one or more processing engines, one or more buffers, or one or more iterator tables. In the example method 1000, the one or more processing engines and the one or more buffers are tightly coupled within an area of the programmable processor such that data communications between components of the programmable processor are exchanged at a first bandwidth that exceeds a threshold based on a placement of the components of the programmable processor relative to each other. Furthermore, the one or more iterator tables comprise an iterator table for each of the one or more buffers, each iterator table comprises an iterator index and a plurality of offset-stride tuples and identifies a multidimensional array stored in a respective buffer, and a subset of the plurality of offset-stride tuples maps each dimension of the multidimensional array to a set of addresses in the respective buffer. And lastly, memory elements used by the one or more processing engines to perform one or more operations using the one or more iterator tables consist of the one or more buffers.

In some embodiments, the one or more buffers excludes a register file associated with a generic processor, the one or more processing engines are configured to communicate with the register file at a second bandwidth that is less than the first bandwidth, and the generic processor is a central processing unit (CPU), a graphics processing unit (GPU), a neural processing unit (NPU), or a vector processor.

In some embodiments, the first instruction configures the iterator table and includes an indication of whether an offset or a stride is being declared, a namespace identifier for the respective buffer, the iterator index, and a value for the offset or the stride based on a respective offset-stride tuple indicated by the iterator index. In some examples, this corresponds to the ITERATOR_CONFIG instruction of the specialized ISA.

In some embodiments, the first instruction configures at least one of the one or more processing engines to perform a binary operation, and includes (a) a first namespace identifier and a first iterator index that addresses a location in a first input buffer that stores a first input of the binary operation, (b) a second namespace identifier and a second iterator index that addresses a location in a second input buffer that stores a second input of the binary operation, and (c) an output namespace identifier and an output iterator index that addresses a location in an output buffer that stores an output of the binary operation. In some examples, this corresponds to the ALU instruction of the specialized ISA. In other examples, the binary operation is an addition operation, a subtraction operation, a multiplication operation, a multiply-and-accumulate operation, a division operation, a maximum operation, a minimum operation, a shift operation, a NOT operation, an AND operation, or an OR operation.

In some embodiments, the first instruction configures an iterative loop and includes an indication of whether a number of iterations or a number of instructions is being declared, a loop identifier, and a value for the number of iterations or the number of instructions. In some examples, this corresponds to the LOOP instruction in the specialized ISA.

In some embodiments, the first instruction configures a datatype and includes a type of the datatype, an indication of whether the datatype is an input datatype or an output datatype, an index in the respective buffer, and a number of bits of the datatype. In some examples, this corresponds to the DATATYPE_CONFIG instruction in the specialized ISA.

In some embodiments, the first instruction configures a conversion of a value from an input datatype to an output datatype, and includes (a) an input namespace identifier and an input iterator index that addresses a location in an input buffer that stores the value in the input datatype and (b) an output namespace identifier and an output iterator index that addresses a location in an output buffer that stores the value in the output datatype. In some examples, this corresponds to the TYPE_CAST instruction in the specialized ISA.

In some embodiments, the programmable processor is operated in conjunction with the generic processor that comprises a general matrix multiplication (GEMM) unit. Herein, the first instruction configures non-overlapping execution time windows for the programmable processor and the GEMM unit, and includes a start time, an end time, and an instruction group identifier. In some examples, this corresponds to the SYNC instruction in the specialized ISA.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A programmable processor, comprising:
one or more processing engines, wherein each processing engine is configured to perform a set of primitive operations;
one or more buffers, wherein at least one buffer is configured to store at least one multidimensional array; and
one or more iterator tables stored in at least another buffer,
wherein the one or more processing engines and the one or more buffers are tightly coupled within an area of the programmable processor such that data communications between components of the programmable processor are exchanged at a first bandwidth that exceeds a threshold based on a placement of the components of the programmable processor relative to each other,
wherein the one or more iterator tables comprise an iterator table for each of the one or more buffers, each iterator table comprising an iterator index and a plurality of offset-stride tuples and identifying a multidimensional array stored in a respective buffer,
wherein a subset of the plurality of offset-stride tuples maps each dimension of the multidimensional array to a set of addresses in the respective buffer, and
wherein memory elements used by the one or more processing engines to perform one or more operations using the one or more iterator tables consist of the one or more buffers.

2. The programmable processor of claim 1, wherein the one or more buffers excludes a register file associated with a generic processor, wherein the one or more processing engines are configured to communicate with the register file at a second bandwidth that is less than the first bandwidth, and wherein the generic processor is a central processing unit (CPU), a graphics processing unit (GPU), a neural processing unit (NPU), or a vector processor.

3. The programmable processor of claim 1, wherein a single instruction, multiple data (SIMD) configuration of the programmable processor comprises time interleaving (a) one or more compute operations performed by at least one of the one or more processing engines and (b) one or more access operations performed on at least one of the one or more buffers.

4. The programmable processor of claim 1, comprising:
a code repeater module configured to receive an instruction from a program counter,
wherein the instruction specifies performing the one or more operations using at least one of the one or more processing engines, the one or more buffers, or the one or more iterator tables.

5. The programmable processor of claim 4, wherein the code repeater module is configured to:
configure, based on the instruction, the one or more iterator tables by computing the set of addresses in the respective buffer using the subset of the plurality of offset-stride tuples; and
perform, using the one or more iterator tables, the one or more operations on every dimension of the multidimensional array stored in the respective buffer.

6. The programmable processor of claim 1, comprising:
a data access engine configured to access additional data from an off-chip memory at a second bandwidth that is less than the first bandwidth, wherein the data access engine is configured to access the additional data from the off-chip memory at a tile granularity, and wherein the programmable processor is configured to process multiple tiles in an intra-tile mode or an inter-tile mode; and
a permute engine configured to receive input data and output a permuted version of the input data based on a predefined permutation sequence.

7. The programmable processor of claim 1, wherein the programmable processor is operable in a standalone configuration for at least one application or in at least one system.

8. The programmable processor of claim 1, wherein the programmable processor is operable in conjunction with a generic processor for at least one application or in at least one system, wherein the generic processor is a central processing unit (CPU), a graphics processing unit (GPU), a neural processing unit (NPU), or a vector processor, and wherein the generic processor comprises a general matrix multiplication (GEMM) unit.

9. The programmable processor of claim 1, wherein the programmable processor uses an instruction set architecture (ISA) comprising a plurality of instructions, and wherein each instruction comprises an operation code and is configured to use at least one of the one or more iterator tables.

10. The programmable processor of claim 1, wherein the set of primitive operations comprises an addition (ADD) operation, a subtraction (SUB) operation, a multiplication (MUL) operation, a division (DIV) operation, a multiply-and-accumulate (MACC) operation, a maximum (MAX) operation and a minimum (MIN) operation.

11. The programmable processor of claim 10, wherein at least one higher-order operation is generated based on the set of primitive operations, and wherein the at least one higher-order operation comprises a sigmoid (SIGMOID) operation, a hyperbolic tangent (TANH) operation, a clip (CLIP) operation, a sign (SIGN) operation, an absolute value (ABS) operation, a SoftMax operation, or a Gaussian error linear unit (GeLU) operation.

12. A method of operating a programmable processor, comprising:
receiving, by the programmable processor, a first instruction from an instruction set architecture designed for the programmable processor; and
performing, based on the first instruction, an operation using at least one of one or more processing engines, one or more buffers, or one or more iterator tables,
wherein each of the one or more processing engines is configured to perform a set of primitive operations, wherein at least one buffer is configured to store at least one multidimensional array, and wherein the one or more iterator tables is stored in at least another buffer,
wherein the one or more processing engines and the one or more buffers are tightly coupled within an area of the programmable processor such that data communications between components of the programmable processor are exchanged at a first bandwidth that exceeds a threshold based on a placement of the components of the programmable processor relative to each other,
wherein the one or more iterator tables comprise an iterator table for each of the one or more buffers, each iterator table comprising an iterator index and a plurality of offset-stride tuples, and identifying a multidimensional array stored in a respective buffer,
wherein a subset of the plurality of offset-stride tuples maps each dimension of the multidimensional array to a set of addresses in the respective buffer, and
wherein memory elements used by the one or more processing engines to perform one or more operations using the one or more iterator tables consist of the one or more buffers.

13. The method of claim 12, wherein the one or more buffers excludes a register file associated with a generic processor, wherein the one or more processing engines are configured to communicate with the register file at a second bandwidth that is less than the first bandwidth, and wherein the generic processor is a central processing unit (CPU), a graphics processing unit (GPU), a neural processing unit (NPU), or a vector processor.

14. The method of claim 12, wherein the first instruction configures the iterator table and includes an indication of whether an offset or a stride is being declared, a namespace identifier for the respective buffer, the iterator index, and a value for the offset or the stride based on a respective offset-stride tuple indicated by the iterator index.

15. The method of claim 12, wherein the first instruction configures at least one of the one or more processing engines to perform a binary operation, and includes (a) a first namespace identifier and a first iterator index that addresses a location in a first input buffer that stores a first input of the binary operation, (b) a second namespace identifier and a second iterator index that addresses a location in a second input buffer that stores a second input of the binary operation, and (c) an output namespace identifier and an output iterator index that addresses a location in an output buffer that stores an output of the binary operation.

16. The method of claim 12, wherein the first instruction configures an iterative loop and includes an indication of whether a number of iterations or a number of instructions is being declared, a loop identifier, and a value for the number of iterations or the number of instructions.

17. The method of claim 12, wherein the first instruction configures a datatype and includes a type of the datatype, an indication of whether the datatype is an input datatype or an output datatype, an index in the respective buffer, and a number of bits of the datatype.

18. The method of claim 12, wherein the first instruction configures a conversion of a value from an input datatype to an output datatype, and includes (a) an input namespace identifier and an input iterator index that addresses a location in an input buffer that stores the value in the input datatype and (b) an output namespace identifier and an output iterator index that addresses a location in an output buffer that stores the value in the output datatype.

19. The method of claim 12, the programmable processor is operated in conjunction with a generic processor that comprises a general matrix multiplication (GEMM) unit, wherein the generic processor is a central processing unit (CPU), a graphics processing unit (GPU), a neural processing unit (NPU), or a vector processor, and wherein the first instruction configures non-overlapping execution time windows for the programmable processor and the GEMM unit, and includes a start time, an end time, and an instruction group identifier.

20. A non-transitory computer-readable medium storing instructions that, when implemented by one or more processors, cause the one or more processors to perform a method for operating a programmable processor, the method comprising:
receiving, by the programmable processor, a first instruction from an instruction set architecture designed for the programmable processor; and
performing, based on the first instruction, an operation using at least one of one or more processing engines, one or more buffers, or one or more iterator tables,
wherein each of the one or more processing engines is configured to perform a set of primitive operations, wherein at least one buffer is configured to store at least one multidimensional array, and wherein the one or more iterator tables is stored in at least another buffer,
wherein the one or more processing engines and the one or more buffers are tightly coupled within an area of the programmable processor such that data communications between components of the programmable processor are exchanged at a first bandwidth that exceeds a threshold based on a placement of the components of the programmable processor relative to each other,
wherein the one or more iterator tables comprise an iterator table for each of the one or more buffers, each iterator table comprising an iterator index and a plurality of offset-stride tuples, and identifying a multidimensional array stored in a respective buffer,
wherein a subset of the plurality of offset-stride tuples maps each dimension of the multidimensional array to a set of addresses in the respective buffer, and
wherein memory elements used by the one or more processing engines to perform one or more operations using the one or more iterator tables consist of the one or more buffers.
